(19) United States
(12) Patent Application Publication
(10) Pub. No.: US 2007/0224423 A1
(43) Pub. Date: Sep. 27, 2007

(54) Cable using a tracking-resistant resin composition

(75) Inventors: Jung Hee Lee, Seoul (KR); Il Gun Soe, Gyeonggi-do (KR); Sun Ho Hwang, Gyeonggi-do (KR)

Correspondence Address: DEMONT & BREYER, LLC, 100 COMMONS WAY, HOLMDEL, NJ, 07733, US

(73) Assignee: LG CABLE LTD., Seoul (KR)

(21) Appl. No.: 11/755,359

(22) Filed: May 30, 2007

Related U.S. Application Data
(62) Division of application No. 10/817,475, filed on Apr. 2, 2004.

(30) Foreign Application Priority Data
Apr. 4, 2003 (KR) 10-2003-0021442

(51) Int. Cl. B32B 1/00

(52) U.S. Cl. 428/375

(57) ABSTRACT

The present invention discloses a tracking resistant resin composition comprising: 100 weight parts of at least one selected from the group consisting of polyolefins and copolymers of different olefins; 0.1 to 1.5 weight parts of carbon black; 0.1 to 2 weight parts of a UV and light stabilizer; and 0.1 to 2 weight parts of an antioxidant and a cable using the same. The tracking resistant resin composition shows excellent tracking resistance, mechanical properties and environmental resistance, easiness of storage and good shelf-life, and excellent processability without inferior appearance in cables.

### BACKGROUND OF THE INVENTION

1. Field of the Invention

The present invention relates to a tracking resistant resin composition and a cable using the same, and more particularly, a tracking resistant resin composition which is used as a outer sheath for a fiber optic cable, particularly an outersheath of a self-supporting fiber optic cable to be installed in a power transmission tower for high-voltage cables and a cable using the same.

2. Background of the Related Art

Materials used for the purposes of reinforcement, inhibition of corrosion, waterproofing to protect cables for outdoor use, and ends of cables and joints between cables include insulation resin compositions comprising thermoplastic resins as a main component.

Such insulation resin compositions are exposed to rain and wind for a long period of times since they are for use in the outside. Also, salts in the vicinity of the seashore, various contaminants and electrolytes including exhaust gases in the industrial area may be attached and accumulated thereon.

In this case, if moisture is attached on the surface by rain, high humidity and the like, a leakage current may flow over the cable with insulation resin composition, particularly, the outer sheath of the cable, cable ends and cable joints. By the joule heat generated by the current flow, a part of the attached moist is evaporated, whereby a conductive path of the leakage current is intercepted.

A high electric field gradient formed on such dry zone where the moist partially evaporates causes electric discharge. By electric discharge, arc is generated and insulation material is carbonized by initial melt and ignition following oxidation. As a result, a carbonized conductive path, so called tracking, is formed, which may cause insulation destruction over the time and ultimately, loss of insulation functions.

The tracking largely affects an outer sheath of an fiber optic communication cables installed near high-voltage overhead lines. In this case, the tracking occurs by complex actions of environmental factors such as an electric field formed over the high-voltage power transmission cables, moisture, solar rays, pollutants and the like. As such tracking occurs, aramid yarn which serves as a strength member is exposed to the outside. The strength member exposed to the outside loses its functions due to deterioration by the outside environment. And that leads loss of cable functions along with destruction of optical fibers.

In order to solve the tracking in cables, conventionally, a metal hydrate such as aluminum hydroxide and magnesium hydroxide, a mixture of aluminum hydroxide and a transition metal, or iron oxide has been used in the insulation resin composition.

For example, Japanese Patent No. 59-68345 discloses a composition comprising: 100 weight parts of a thermoplastic resin, rubber or a mixture thereof; at least 20 weight parts of magnesium hydroxide and at least 4 weight parts of iron oxide, in which the sum of the ingredients is up to 200 weight parts. Japanese Patent No. 3-26734 discloses a tracking resistant material comprising, 100 weight parts of a thermally modified thermoplastic resin, rubber or a mixture thereof, 500 to 2000 weight parts of a thermoplastic rubber, in which 20 to 50 weight parts of magnesium hydroxide is added to the composition, based on 100 weight parts of the sum of the resin composition.

Also, U.S. Pat. No. 4,673,247 discloses a use of a polymer resin in the form of a mixture comprising 30% by weight to 60% by weight, preferably about 50% by weight, of a hydrate of a metal such as magnesium, aluminum, and the like, as an outer sheath.

Arc is generated by electric charge on the surface of the dielectric material containing metal hydrate. By the high temperature of the arc, the dielectric material is decomposed while the hydroxide undergoes dehydration at the same time. The moisture generated by the dehydration lowers the temperature of the heat generated by the arc, thereby inhibiting the decomposition of the dielectric material. Also, even when ignition occurs, the generated moisture delays carbonization by the ignition, thereby inhibiting the occurrence of the tracking.

However, the conventional methods employing a metal hydrate to inhibit the tracking have the following problems.

Firstly, a metal hydrate is an impurity to the dielectric material and thereby, shows poor compatibility with the dielectric material of a polymeric substance. The metal hydrate is apt to aggregate when the metal hydrate is mixed in a open roll or internal mixer, thereby causing deterioration of mechanical properties such as tensile strength and elongation at break and processibility.

Secondly, since a metal hydrate increases density of the sheath, the weight of the cable such as self-supporting fiber optic cable is increase and the cable is drooped by the self weight. Therefore it is needed to reduce the span between pylons or reinforce the structure of the cable.

Thirdly, due to the deterioration in resistance to environment and migration of a metal hydrate to the surface over the time, the metal hydrate is one of the factors causing the surface contamination. Further, because a metal hydrate increases hydrophilicity of the cable, leakage current flows on the surface of the cable. Consequently, a dry zone is formed and the possibility of tracking occurrence by arc is increased.

Fourthly, a dielectric material containing a metal hydrate in a large amount shows hygroscopicity absorbing moisture in the air. Because of the hygroscopicity, the dielectric material should be stored in a hermetically sealed state and processed after being sufficiently dried. Otherwise, when the cable is manufactured, bubbles may be formed on the surface of the cable. Resultantly, the appearance of the cable become inferior.

Meanwhile, the tensile load applied on a cable varies according to weight of the cable. For cables having the same structure and same size, the weights of the cables are affected by the outer sheath applied thereon, whereby the needed amount of a strength member is different.

However, as a large amount of the hydroxide is contained in the outer sheath of the cable, the mechanical properties of the outer sheath are reduced and the density of the outer sheath is increased. And thereby, the weight of the cable is increased. Therefore, the strength member is needed in a more increased amount. In order to solve these, for example, International Patent WO No. 99/04300 discloses a method for forming a double-layered outer sheath by extrusion, in which the inner layer of the outer sheath is a layer of a non-tracking resistant polymer material and the outer layer is a layer of a polymer comprising 40 to 70% by weight of an inorganic oxide or hydroxide. The amount of the inorganic oxide or hydroxide is preferably 50 to 70% by weight, more preferably 55 to 65% by weight.

However, this technique further comprises an extrusion process to form a double-layered outer sheath, which makes the total process complicated. Also, since the outer sheath is separated into two layers, the inner layer without tracking resistance and the outer layer with tracking resistance, it is impossible to avoid the weight increase by the tracking resistant material used in the outer layer, though the cable weight is reduced by the amount of the polymer material without tracking resistance used in the inner layer. Also, the thickness of the outer layer should be reduced as large as the thickness of the inner layer without tracking resistance, which consequently causes deterioration in long-term reliability.

### SUMMARY OF THE INVENTION

Therefore, the present invention has been made to solve the above-described problems, and it is an object of the present invention to provide a tracking resistant resin composition which shows resistance to tracking phenomenon, excellent mechanical properties, environmental resistance and low density in a cable, particularly self-supporting optical communication cables made of a dielectric material installed near high voltage overhead lines, thereby providing lightness and long-term reliability to a produced cable, and a cable using the same.

In accordance with the present invention, the object is accomplished by a tracking resistant resin composition comprising:

100 weight parts of at least one resin selected from the group consisting of polyolefins and copolymers of different olefins;

0.1 to 1.5 weight parts of a carbon black;

0.1 to 2 weight parts of a UV and light stabilizer; and

0.1 to 2 weight parts of an antioxidant.

Preferably, the carbon black has an average particle size of 60 nm or less, a surface area of 80 to 200 m²/g, a dibutyl acrylate adsorption of 100 to 200 cm³/100 g.

Also, the present invention provides a cable having a dielectric protective layer comprising the tracking resistant resin composition as described above.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a schematic view showing a cross-section of the self-supporting type non-metal optical cable according to an example of the present invention.

### DETAILED DESCRIPTION OF THE PREFERRED EMBODIMENT

Reference will now be made in detail to the preferred embodiments of the present invention, examples of which are illustrated in the accompanying drawings.

Now, the tracking resistant resin composition according to the present invention and the cable using the same will be explained in detail.

The tracking resistant resin composition according to the present invention is different from the conventional art to inhibit arc on a dry zone by endothermic reaction and moisture resulting from the decomposition of a metal hydrate and tracking caused thereby. The present invention is based on a technical concept to improve tracking resistance, along with environmental resistance, low density, storage property and processability by employing a carbon black.

The tracking resistant resin composition according to the present invention comprises at least one resin selected from the group consisting of polyolefins and copolymers of different olefins and additionally, a UV and light stabilizer and an antioxidant.

Preferable examples of the polyolefins which can be used in the present invention include LDPE (low density polyethylene), MDPE (medium density polyethylene) and HDPE (high density polyethylene) which has a melt index of 0.1 to 1.0 g/10 min. The copolymer of different olefins which can be used in the present invention is one of ethylene vinyl acetate, ethylene ethyl acrylate, and ethylene butyl acrylate of ethylene-alpha-copolymer, or a mixture of two or more thereof.

The melt index (MI) is a numerical index showing melt viscosity of a thermoplastic polymer. The melt index can be obtained by two types of method. One of them is a method to examine melt index of polyethylene and the like by measuring flow rate using an extrusion plastometer and the other includes measuring weight of an extrudate from an orifice having an inner diameter of 2.095±0.005 mm and a length of 8.001±0.025 mm. The first method is suitable for a material having a melt index of 0.1 to 0.7 g/10 min. A load of 2,160±10 g including a piston is applied to a specimen and the melt index is measured at 190±0.4□. A cylinder is packed with 3 g of a specimen and a piston is fitted therein. The extrudate for 5 minutes after application of the load is cut off. Then, the extrudate from the orifice for the next 6 minutes was measured for its weight at a precision of ±2%. The second method is applicable to a material having a melt index of 0.7 to 10 g/10 min. The extrudate from the orifice for 2 minutes after application of the load is cut off and the extrudate for the next 3 minutes is measured for its weight and converted into g/10 min as a melt index. According to the present invention, the first method is preferable, since polyethylene which is used as polyolefines has a melt index of 0.1 to 1.0 g/10 min, the melt index can be measured without limitation to the first method.

The carbon black which can be used in the present invention includes preferably furnace black, acetylene black and thermal black and more preferably furnace black.

Preferably, carbon black has an average particle size of 60 nm or less, a surface area of 80 to 200 m²/g and a dibutyl acrylate adsorption of 100 to 200 cm³/100 g, more preferably an average particle size of 30 nm or less, a surface area of 100 to 170 m²/g and a dibutyl acrylate adsorption of 100 to 150 cm³/100 g.

Also, its content is preferably 0.1 to 1.5 weight parts, more preferably 0.3 to 1.0 weight parts. The use of the carbon black, particularly having the foregoing particle size and surface area, reduce deterioration of mechanical properties and density increase, solve the problems related to storage and processing due to absorption of moisture in the air, and prevent arc occurrence in a dry zone caused by leakage current resulting from the formation of a conductive path in a high electric field, thereby inhibiting tracking.

The UV and light stabilizer which can be used in the present invention is preferably at least one selected from the group consisting of piperidines, benzophenones and benzotriazoles, more preferably at least one selected from the group consisting of methyl piperindines and a benzophenones, most preferably at least one selected from the group consisting of 2,2,6,6,-methyl piperindines and a 2-(2′-hydroxyphenyl)-benzotriazoles, particularly preferably at least one selected from the group consisting of N—C₁-C₈ alkyl-substituted derivatives of a 2,2,6,6-tetramethyl-1-piperidines.

Preferred examples of the piperidines UV and light stabilizer which can be used in the present invention include 2,2,6,6-methyl piperidines such as 2,2,6,6-pentamethyl-4-piperidinyl, N-butyl-2,2,6,6-tetramethyl-4-piperidine amine, hexanediyl(2,2,6,6-tetramethyl-4-piperidinyl)imino and 4-hydroxy-2,2,6,6-tetramethyl-1-piperidine.

Preferred examples of the benzophenones UV and light stabilizer which can be used in the present invention include compounds of the 2,4-dihydroxy phenone structure which is substituted with a C₁-C₈ alkyl group, a C₆-C₁₂ cycloalkyl group or a C₁-C₈ alkoxy group.

Preferred examples of the benzotriazoles UV and light stabilizer which can be used in the present invention include compounds of 2-(2′-hydroxyphenyl)-benzotriazole structure which is substituted with a chlorine at 5 position and an alkyl group at 3′ and 5′ positions.

The UV and light stabilizer is preferably contained in an amount of 0.1 to 2 weight parts, more preferably in an amount of 0.3 to 1 weight parts. By using the stabilizer within the foregoing range, weather resistance required to ensure long-term reliability can be provided.

The antioxidant which can be used in the present invention is preferably at least one selected from the group consisting of hindered phenol antioxidants, phosphite antioxitants and sulfur-containing antioxidants, more preferably at least one selected from the group consisting of hindered phenols and thios, particularly preferably a mixture of hindered phenols and thios in a ratio of 1:1.3.

Preferred examples of the hindered phenol antioxidant include tetrakis(3-(3,5-di-tert-butyl-4-hydroxyphenyl)propionate, thiodiethylene-bis(3-(3,5-di-tert-butyl-4-hydroxyphenyl)propionate, 6,6′-di-tert-butyl-2,2′-thiodi-p-cresol or a mixture thereof.

Preferred examples of the phosphite antioxidant which can be used in the present invention include tris(2,4-di-tert-butylphenyl)phosphite, di-tert-butylphenyl phosphonite or a mixture thereof.

Preferred examples of the sulfur-containing antioxidant include thios such as dilauryl thiopropionate, dimyristyl thiodipropionate or a mixture thereof.

The antioxidant is contained preferably in an amount of 0.1 to 2 weight parts, more preferably in an amount of 0.2 to 1 weight parts. By using the antioxidant within the foregoing range, it is possible to prevent oxidation of a dielectric material by heat, thereby providing thermal resistance. Accordingly, it shows synergy effect along with the light stabilizer and thus, contributes to the improvement of weather resistance.

The tracking resistant resin composition according to the present invention is used in cables, particularly an outer sheath of cables, ends of cables and joints between cables. Also, it can be used for the purposes of reinforcement, inhibition of corrosion, waterproofing to protect an outer sheath, that is, a dielectric protective layer, of self-supporting type non-metal optical communication cables installed in the vicinity of high voltage overhead lines, or for the purpose to prevent tracking. Further, it can be applied as a material of products manufactured by a common processing technology, such as extrusion, injection, blow molding, press and the like.

Now, the cable according to an example of the present invention is explained. The cable according to an example of the present invention is prepared by extruding the tracking resistant resin composition according to the present invention to form a dielectric protective layer having mechanical properties, environmental resistance and tracking resistance.

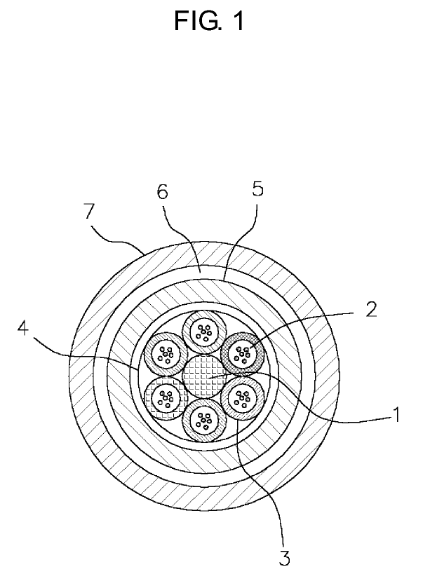

FIG. 1 is a schematic view showing a cross-section of the self-supporting type non-metal optical cable according to an example of the present invention. As shown in FIG. 1, the self-supporting type non-metal optical cable according to an example of the present invention comprises an optical unit 4, an inner protective layer 5 to shield the outside of the optical unit 4, a strength member 6 comprising, for example, glass fiber or aramid yarn able to support tensile stress outside the inner protective layer 5 and a dielectric protective layer 7 comprising the tracking resistant resin composition according to the present invention to shield the strength member 6.

The optical unit 4 comprises at least one optical fibers and a plurality of polymer tubes 3, for example, polybutylene terephthalate tubes, packed with gel 2 to prevent propagation of water. The tubes 3 are twisted around a central strength member 1 consisting of a glass fiber reinforcing plastic to minimize thermal shrinkage of the cable.

Upon installation of the above-described optical communication cable along a high-voltage transmission line, particularly, when an outer dielectric protective layer 7 of the cable is consisted of the tracking resistant resin composition according to the present invention, the total weight of the cable is reduced. Also, when the cable is installed, the tensile load of the cable is reduced and the number of aramid yarns as a strength member is reduced.

Now, the present invention will be explained in further detail by preferred embodiments of the present invention. However, the present invention is not limited to the following examples and various forms of embodiments can be made in the attached claims. The following examples are to bring the disclosure of the present invention to perfection and for the skilled in the art to readily practice the present invention.

### EXAMPLE

The polymer compositions according to the following Examples and Comparative Examples were mixed at about 160 to 170□ for about 10 to 20 minutes using an open roll or closed type instrument such as a kneader or Banbury mixer to form a sheet. The sheet was then pressed at 170□ for 10 minutes using an electrical heating press and cooled for 5 minutes to prepare a specimen for the tracking test and property evaluation.

In Table 1, weight ratios of Examples 1 to 7 are shown.

TABLE 1

| | Example | | | | | | | | | |
|---|---|---|---|---|---|---|---|---|---|---|
| | 1 | 2 | 3 | 4 | 5 | 6 | 7 | 8 | 9 | 10 |
| MDPE | 100 | 100 | 100 | 100 | 100 | 100 | 100 | — | 0 | 0 |
| HDPE | — | — | — | — | — | — | — | 100 | — | — |
| EVA | — | — | — | — | — | — | — | — | 100 | — |
| EEA | — | — | — | — | — | — | — | — | — | 100 |
| Antioxidant (1) | 0 | 0 | 0 | 0.6 | 1 | 0.8 | 1.2 | 0.6 | 0.5 | 0.5 |
| Antioxidant (2) | 0 | 0 | 0 | 0.4 | 0 | 0.5 | 0.8 | 0.4 | 0.3 | 0.3 |
| Carbon black | 0.5 | 1.5 | 0.5 | 0.5 | 0.5 | 0.5 | 0.5 | 0.5 | 0.5 | 0.5 |
| Light stabilizer (3) | — | — | 1 | 1 | 1 | 1 | 1 | 1 | 1 | 1 |

In Table 1, Example 1 and Example 2 were compositions consisting of MDPE polymerized by the low pressure method and having a density of 0.938 g/cm³ and a melt flow rate (MFR) of 0.4 and 0.5 and 1.5 weight parts, respectively, of a carbon black. The melt flow rate is a mass of a thermoplastic material extruded through a orifice set under a specific conditions in a given time and also referred to as a flow rate. The term MFI (Melt Flow Index) also refers to MFR. Therefore, MFR and MFI are used as the same meaning in this specification.

Example 3 used a light and UV stabilizer to prevent deterioration by environmental factors (UV, light, moisture, etc.) in outdoor use. Example 4 used an antioxidant to prevent deterioration of properties due to long-term oxidation by heat. Example 4 used hindered phenols in combination with thios to maximize the effect of antioxidation and environmental resistance.

Example 5 used thios alone as an antioxidant.

Example 6 and 7 used a light stabilizer and an antioxidant in a different amount, respectively.

Example 8 illustrated a composition of HDPE having a density of 0.943 g/cm³ and a MFR of 0.4 and Example 9 and 10 illustrated compositions of an ethylene copolymer.

The ethylene vinyl acetate copolymer contain 16% vinyl acetate content having a MRI of 0.4 and the ethylene-ethyl acrylate (EEA) contain 15% ethyl acrylate content having a MRI of 0.5.

The antioxidant (1) is thios and the antioxidant (2) is hindered phenols. Also, the light stabilizer (3) is 2,2,6,6-methylpiperidines.

In Table 2, weight ratios of Comparative Examples 1 to 3 are shown.

TABLE 2

| | Comparative Example | | |
|---|---|---|---|
| | 1 | 2 | 3 |
| MDPE | 100 | — | — |
| HDPE | — | 100 | 100 |
| Antioxidant (1) | 0.5 | 0.5 | 0.5 |
| Antioxidant (2) | 0.3 | 0.3 | 0.3 |
| Carbon black | 2.5 | 2.5 | 2.5 |
| Magnesium hydroxide | — | — | 50 |

Comparative Example 1 comprised 2.5 weight parts carbon black and common MDPE material used as a jacket material of optical communication cables.

Comparative Example 2 comprised 2.5 weight parts carbon black and HDPE jacket material.

Comparative Example 3 further comprised 50 weight parts magnesium hydroxide (Mg(OH)₂), in addition to Comparative Example 2, in which the magnesium hydroxide (Mg(OH)₂) had its surface coated with a fatty acid and had an average particle size of 0.8 μm.

The valuation methods to compare characteristics of respective constructions of the above-described Examples and Comparative Examples were performed according to the methods of IEC (International Electrotechnical Commission) 811-1 for the mechanical properties. The environmental resistance of Examples and Comparative Examples was tested according to UL1581 sunlight resistance test.

The tracking properties were tested according to ASTM2303. Contaminant solution having a resistance of 370 to 400Ω·cm and comprising 0.1% by weight of ammonium chloride, 0.02% by weight of a surfactant and distilled water were supplied on the surface of a specimen at a rate of 0.3 Ml/min while applying a voltage of 3.0 kV. And time to track was measured.

In order to evaluate age property by heat, a specimen was subjected to age in an air circulation oven at 100□ for 168 hours and measured for residual rate in tensile strength and elongation.

In Table 3, evaluation results of mechanical properties, environmental resistant properties, tracking properties, thermal aging properties, density, storage and processability of Examples are shown.

TABLE 3

| | | | Example | | | | | | | | | |
|---|---|---|---|---|---|---|---|---|---|---|---|---|
| Property | Items | | 1 | 2 | 3 | 4 | 5 | 6 | 7 | 8 | 9 | 10 |
| Mechanical | 1) Tensile | | 2.50 | 2.35 | 2.32 | 2.30 | 2.30 | 2.31 | 2.00 | 2.33 | 1.9 | 2.0 |
| properties | strength | | | | | | | | | | | |
| | (kg/mm²) | | | | | | | | | | | |
| | 1) Elongation | | 780 | 800 | 750 | 740 | 730 | 750 | 840 | 770 | 750 | 700 |
| | (%) | | | | | | | | | | | |
| Enviromental | 870 hr | Residual | 80 | 85 | 85 | 86 | 82 | 84 | 80 | 84 | 81 | 79 |
| resistant | | tensile | | | | | | | | | | |
| properties | | strength | | | | | | | | | | |
| | | (%) | | | | | | | | | | |
| | | Residual | | | | | | | | | | |
| | | elongation | 85 | 88 | 90 | 95 | 90 | 92 | 89 | 89 | 81 | 80 |
| | | (%) | | | | | | | | | | |
| | 1000 hr | Residual | 74 | 82 | 80 | 85 | 82 | 80 | 80 | 80 | 80 | 75 |
| | | tensile | | | | | | | | | | |
| | | strength | | | | | | | | | | |
| | | (%) | | | | | | | | | | |
| | | Residual | 80 | 85 | 87 | 92 | 90 | 87 | 87 | 85 | 80 | 76 |
| | | elongation | | | | | | | | | | |
| | | (%) | | | | | | | | | | |

| | | | | | | | | | | | |
|---|---|---|---|---|---|---|---|---|---|---|---|
| Tracking | 3) Time to | 600 | 300 | 550 | 500 | 490 | 430 | 420 | 620 | 300 | 400 |
| properties | tracking at 3.0 kV | | | | | | | | | | |
| | (min) | | | | | | | | | | |
| Thermal aging | Residual tensile | 80 | 82 | 78 | 94 | 85 | 90 | 92 | 90 | 89 | 90 |
| properties | strength (%) | | | | | | | | | | |
| | Residual | 85 | 83 | 84 | 99 | 90 | 92 | 95 | 95 | 90 | 92 |
| | elongation (%) | | | | | | | | | | |
| Density | g/cm³ | 0.940 | 0.942 | 0.940 | 0.940 | 0.940 | 0.940 | 0.940 | 0.945 | 0.927 | 0.940 |
| Storage and | | 0 | 0 | 0 | 0 | 0 | 0 | 0 | 0 | 0 | 0 |
| processability | | | | | | | | | | | |

In Table 4, evaluation results of mechanical properties, environmental resistant properties, tracking properties, thermal aging properties, density, storage and processability of Comparative Examples are shown.

TABLE 4

| | | | Comparative | | |
|---|---|---|---|---|---|
| | | | Example | | |
| Property | Items | | 1 | 2 | 3 |
| Mechanical | 1) Tensile strength (kg/mm²) | | 2.28 | 2.30 | 1.05 |
| properties | 1) Elongation (%) | | 750 | 760 | 380 |
| Environmental | 870 hr | Residual tensile | 85 | 86 | 65 |
| resistant | | strength (%) | | | |
| properties | | Residual elongation | 88 | 86 | 75 |
| | | (%) | | | |
| | 1000 hr | Residual tensile | 82 | 80 | 59 |
| | | strength (%) | | | |
| | | Residual elongation | 85 | 81 | 50 |
| | | (%) | | | |

| | | | | |
|---|---|---|---|---|
| Tracking | 3) time to tracking at 3.0 kV | 60 | 70 | 500 |
| properties | (min) | | | |
| Thermal | Residual tensile strength (%) | 85 | 86 | 80 |
| aging | Residual elongation (%) | 86 | 85 | 79 |
| properties | | | | |
| Density | g/cm³ | 0.943 | 0.948 | 1.20 |
| Storage and | | 0 | 0 | x |
| process- | | | | |
| ability | | | | |

As can be seen from Table 4, Comparative Example 3, in which a metal hydrate was used to give tracking resistant showed more excellent tracking resistance than Comparative Examples 1 and 2 which were jacket materials for common optical cables.

However, since the metal hydrate had poor compatibility with polymer, it showed significant deterioration in physical properties after mixing. The addition of the metal hydrate was accompanied with density increase causing an increase in weight of a produced cable and reduced weather resistance to secure reliability in long-term use. Particularly, for weather resistance, the requirement of 80% or more of the residual tensile strength and residual elongation after 720 hr of UL 1581 was not satisfied and thus, considerable attention should be paid.

Also, with respect to the storage and processability, it was necessary to store the metal hydrate in a hermetically sealed container so that it did not absorb moisture in the air. Further, unless the metal hydrate was completely dried in an air oven before processing, bubbles were formed on the surface of the cable during processing.

On the other hand, the resin composition according to the Examples of the present invention showed excellent mechanical properties, environmental resistant properties and tracking property and made it possible to produce light cable without problems related to storage and processing.

Meanwhile, using each of the resin compositions of Examples 1, 2, 4, 8, 9 and 10, and Comparative Example 1, 2 and 3, a dielectric protective layer of a cable was manufactured and measured for weight per unit volume, cable weight, tensile load and the number of strength member upon installation.

For measurement, the distance between pylons (span, L) was set to 400 m, the cable sag (sag S) was set to 4 m which is 1% of the distance between pylons, the outer diameter of the cable (D) was set to 15.2 mm, the diameter (d) excluding the outer sheath was set to 13.2 mm, the cable weight (W) excluding the outer sheath was set to 110 kg/km, the rigidity of the individual strength member (E) was set to 6500 kg and the tensile window (TW) was set to 0.5%.

Where the weight per unit volume of the outer sheath is designated α, the total weight of the cable can be calculated by the following equation.
Wt=W+(n/4)(D²−d²)×α [Formula 1]

The tensile load upon installation (Tᵢ) can be calculated by the following equation.
Tᵢ=Wt×L²/(8×S) [Formula 2]

The number of the aramid yarn as a strength member is determined to be the same with the tensile strength for installation of the cable and can be calculated by the following equation, considering the tensile window.
number of strength member=W/(E×TW) [Formula 3]

In Table 5, the results measuring weight per unit volume of each dielectric protective layer by Examples 1, 2, 4, 8, 9 and 10 and Comparative Examples 1, 2 and 3, weight of a cable comprising the dielectric protective layer, and tensile strength and the number of strength member upon installation of the cable are shown.

TABLE 5

| | |
|---|---|
| | Comparative |
| Example | Example |

| Items | Unit | 1 | 2 | 4 | 8 | 9 | 10 | 1 | 2 | 3 |
|---|---|---|---|---|---|---|---|---|---|---|
| Weight per | kg/dm³ | 0.940 | 0.942 | 0.940 | 0.960 | 0.927 | 0.940 | 0.943 | 0.948 | 1.30 |
| unit volume | | | | | | | | | | |
| Cable weight | kg/km | 170.0 | 170.8 | 170.7 | 171.9 | 170 | 170.7 | 170.8 | 171.2 | 193.9 |
| (Wt) | | | | | | | | | | |
| Tensile load | Kgf | 853.3 | 853.9 | 853.3 | 859.7 | 850.1 | 853.3 | 854.2 | 855.9 | 969.4 |
| upon | | | | | | | | | | |
| installation | | | | | | | | | | |
| (Tᵢ) | | | | | | | | | | |
| strength | Number of | 26 | 26 | 26 | 26 | 26 | 26 | 26 | 26 | 30 |
| member | strength | | | | | | | | | |
| | member | | | | | | | | | |

As can be seen from Table 5, the Examples according to the present invention showed reduction in weight per unit volume, as compared to the Comparative Examples, and thereby, reduction in cable weight. Also, it was noted that the Examples according to the present invention had reduced tensile load and the number of strength member upon installation.

The tracking resistant resin composition according to the present invention shows excellent tracking resistance, mechanical properties and environmental resistance, easiness of storage and excellent processability without inferior appearance in cables, particularly self-supporting optical communication cables of a dielectric material installed near high voltage overhead lines. Also, the composition can accomplish lightness and long-term reliability of cables.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the claims.

What is claimed is:

1. A cable having a dielectric protective layer comprising:
100 weight parts of at least one resin selected from a group consisting of polyolefins and olefin copolymers;
0.3 to 1.0 weight parts of a carbon black;
0.1 to 2 weight parts of a UV and light stabilizer; and
0.1 to 2 weight parts of an antioxidant;
wherein the polyolefins comprise LDPE (low density polyethylene), MDPE (middle density polyethylene), or HDPE (high density polyethylene) which have a melt index of 0.1 to 1.0 g/10 min;
and wherein the carbon black has an average particle size of 60 nm or less, a surface area of 80 to 200 m²/g, and a dibutyl acrylate adsorption of 100 to 200 cm³/100 g.

2. The cable according to claim 1, in which the carbon black has an average particle size of 30 nm or less, a surface area of 100 to 170 m²/g and a dibutyl acrylate adsorption of 100 to 150 cm³/100 g.

3. The cable according to claim 1, in which the UV and light stabilizer is at least one selected from the group consisting of piperidines, benzophenones and benzotriazoles.

4. The cable according to claim 3, in which the benzophenones UV and light stabilizer is a compound of the 2,4-dihydroxy phenone structure which is substituted with a C₁-C₈ alkyl group, a C₆-C₁₂ cycloalkyl group or a C₁-C₈ alkoxy group.

5. The cable according to claim 3, in which the benzotriazoles UV and light stabilizer is a compound of the 2-(2′-hydroxyphenyl)-benzotriazole structure which is substituted with a chlorine at 5 position and an alkyl group at 3′ and 5′ positions.

6. The cable according to claim 3, in which the piperidines is a 2,2,6,6-methyl piperidine.

7. The cable according to claim 6, in which the 2,2,6,6-methyl piperidine is at least one selected from the group consisting of 2,2,6,6-pentamethyl-4-piperidinyl, N-butyl-2,2,6,6-tetramethyl-4-piperidine amine, hexanediyl(2,2,6,6-tetramethyl-4-piperidinyl)imino and 4-hydroxy-2,2,6,6-tetramethyl-1-piperidine.

8. The cable according to claim 3, in which the UV and light stabilizer is any one of methyl piperidines and benzophenones or a mixture thereof.

9. The cable according to claim 3, in which the UV and light stabilizer is any one of 2,2,6,6-methyl piperidines and 2-(2′-hydroxy phenyl)-benzotriozoles or a mixture thereof.

10. The cable according to claim 3, in which the UV and light stabilizer is at least one of N-C₁-C₈ alkyl-substituted derivatives of a 2,2,6,6-tetramethyl-1-piperidines.

11. The cable according to claim 1, in which the UV and light stabilizer is 0.3 to 1 weight parts relative to 100 weight parts of the resin.

12. The cable according to claim 1, in which the antioxidant is at least one selected from the group consisting of hindered phenol antioxidants, phosphite antioxidants and sulfur-containing antioxidants.

13. The cable according to claim 12, in which the hindered phenol antioxidant is at least one selected from the group consisting of tetrakis(3-(3,5-di-tert-butyl-4-hydroxy phenyl)propionate), thiodiethylene-bis(3-3,5-di-tert-butyl-4-hydroxy phenyl)propionate and 6,6′-di-tert-butyl-2,2′-thiodi-p-cresol.

14. The cable according to claim 12, in which the phosphite antioxidant is any one of tris(2,4-di-tert-butyl phenyl)phosphite and di-tert-butyl phenyl phosphonite or a mixture thereof.

15. The cable according to claim 12, in which the sulfur-containing antioxidant is any one of dilauryl thiopropionate and dimyristyl thiodipropionate or a mixture thereof.

16. The cable according to claim 1, in which the antioxidant is 0.2 to 1 weight parts relative to 100 weight parts of the resin.
